(19) United States
(12) Patent Application Publication
(10) Pub. No.: US 2012/0062433 A1
(43) Pub. Date: Mar. 15, 2012

(54) FLEXIBLE ANTENNAS AND RELATED APPARATUSES AND METHODS

(75) Inventors: Constantine A. Balanis, Mesa, AZ (US); David R. Allee, Phoenix, AZ (US)

(73) Assignees: Behalf of Arizona State University, Scottsdale, AZ (US); Arizona Board of Regents, a Body Corporate of the State of Arizona Acting for and on

(21) Appl. No.: 13/298,504

(22) Filed: Nov. 17, 2011

Related U.S. Application Data
(63) Continuation of application No. PCT/US10/34984, filed on May 14, 2010.
(60) Provisional application No. 61/252,105, filed on Oct. 15, 2009.
(60) Provisional application No. 61/180,592, filed on May 22, 2009.

(51) Int. Cl. H01Q 1/44; H01P 11/00; H01J 9/20; H01Q 1/38; H01Q 9/28

(52) U.S. Cl. 343/720; 343/700 MS; 343/795; 445/24; 29/600

(57) ABSTRACT

Embodiments of antennas over flexible substrates are described herein. Other embodiments and related methods are also disclosed herein.

### CLAIM OF PRIORITY

This application is a continuation of PCT Application No. PCT/US2010/034984, filed May 14, 2010, which claims the benefit of (a) U.S. Provisional Patent Application No. 61/252,105, filed Oct. 15, 2009, and (b) U.S. Provisional Patent Application No. 61/180,592, filed May 22, 2009. PCT Application No. PCT/US2010/034984, U.S. Provisional Patent Application No. 61/252,105, and U.S. Provisional Patent Application No. 61/180,592 are incorporated herein by reference.

### STATEMENT REGARDING FEDERALLY SPONSORED RESEARCH OR DEVELOPMENT

At least part of the disclosure herein was funded with government support under grant number W911NF-04-2-0005, awarded by the Army Research Laboratory, and grant number W911W6-06-D-0002, awarded by the Army Aviation Technology Directorate. The United States Government may have certain rights in this invention.

### FIELD OF THE INVENTION

This invention relates generally to antennas, and relates more particularly to flexible antennas and related apparatuses and methods.

### BACKGROUND

Modern electronics technology has progressed to the level where myriad electronic devices can be designed and developed over substrates via semiconductor processes, and such devices often need antennas to serve as their “eyes,” “mouth,” and “ears” for communication with the rest of the world. Successful and efficient communication depends, in part, on the design and performance of such antennas. So far, however, such electronic devices have had to depend on couplings to distinct external and/or separate antennas, thereby increasing cost and complexity, and decreasing the reliability of the communications to and from the devices.

Accordingly, a need exists for antennas that can be coupled integrally over the substrate of such electronic devices, such as antennas that share a metallization layer with the electronic devices. The need may be further accentuated in developing fields such as in flexible electronics, where antennas may be required to flex along with flexible substrates without jeopardizing connectivity with respective electronic devices over the flexible substrates.

### BRIEF DESCRIPTION OF THE DRAWINGS

To facilitate further description of the embodiments, the following drawings are provided in which:

FIG. 1 illustrates a diagram of a portion of an antenna apparatus having an antenna over a flexible substrate in accordance with the present disclosure.

FIG. 2 illustrates a diagram of exemplary dimensions for the antenna of the antenna apparatus of FIG. 1.

FIG. 3 illustrates a cross sectional view of a portion of the antenna apparatus of FIG. 1 along line I-I.

FIG. 4 illustrates a top view of an implementation of the antenna apparatus of FIG. 1.

FIG. 5 illustrates a return loss graph for the antenna apparatus of FIG. 1.

FIG. 6 illustrates a three-dimensional gain pattern graph for the antenna apparatus of FIG. 1.

FIG. 7 illustrates a surface current density graph for the antenna apparatus of FIG. 1.

FIG. 8 illustrates a diagram of another antenna apparatus similar to the antenna apparatus of FIG. 1 but with a hollow inner portion.

FIG. 9 illustrates a flowchart of a method for providing an antenna over a flexible substrate in accordance with the present disclosure.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In one embodiment, an apparatus comprises a substrate and an antenna layer over the substrate. The substrate can be flexible and/or plastic, and the antenna layer can be configured to flex with the substrate. In the same or other embodiments, the apparatus can further comprise one or more semiconductor devices over a substrate having a dielectric material, and an antenna layer can comprise a portion of a structure or layer of at least one of the one or more semiconductor devices.

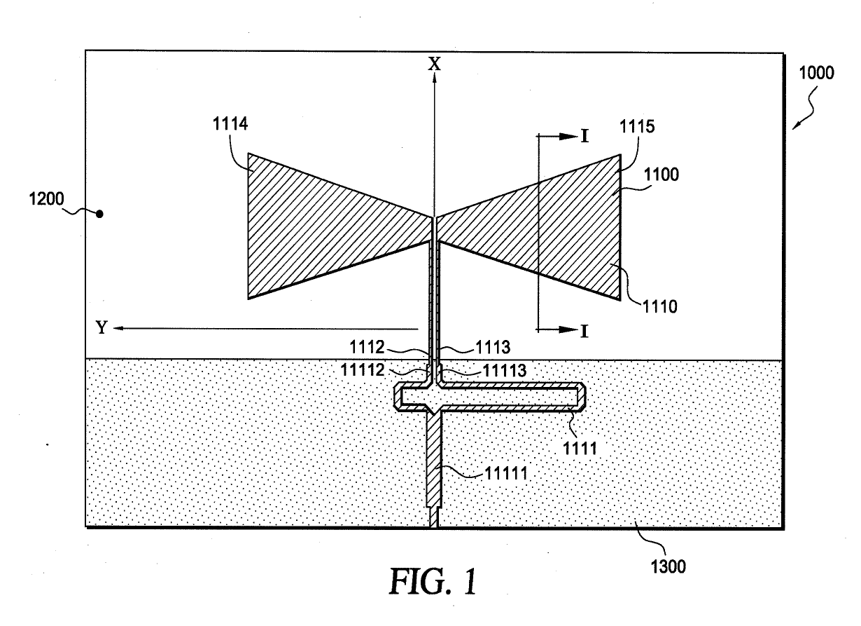

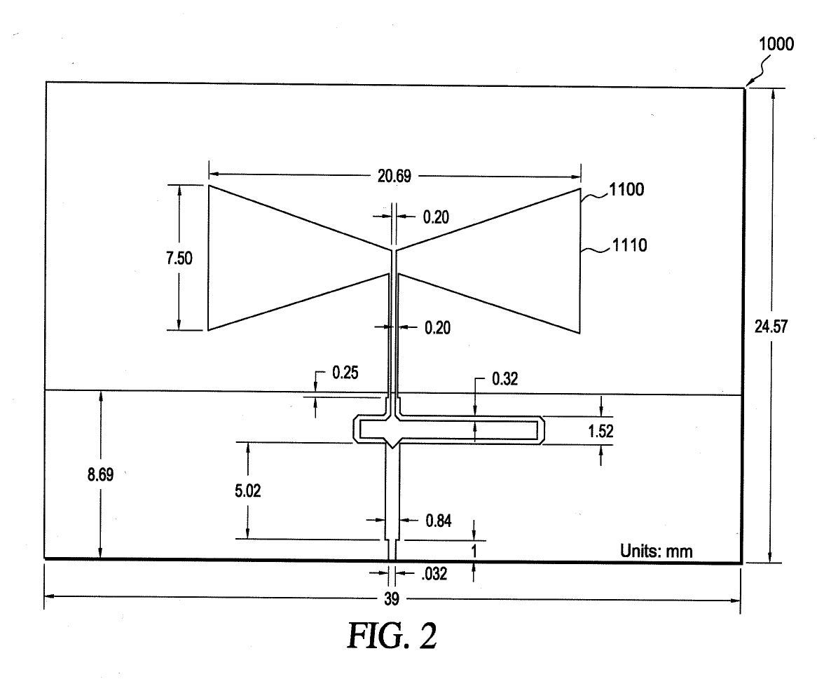

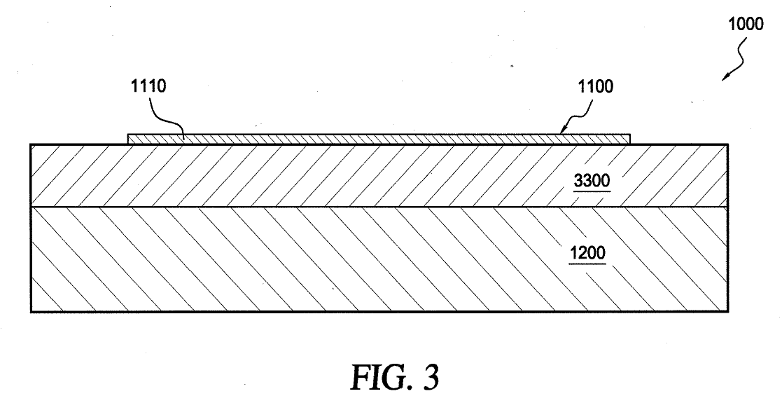

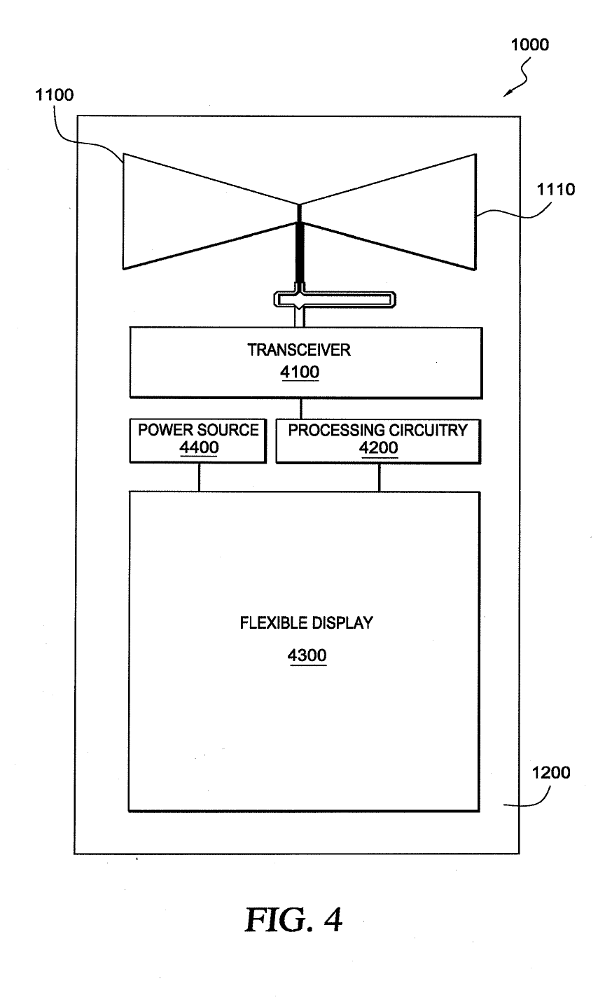

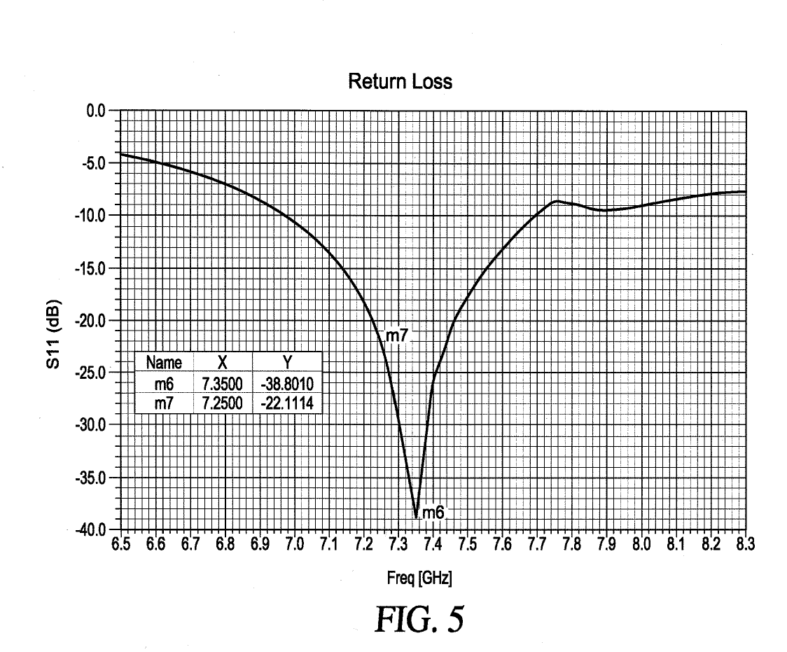

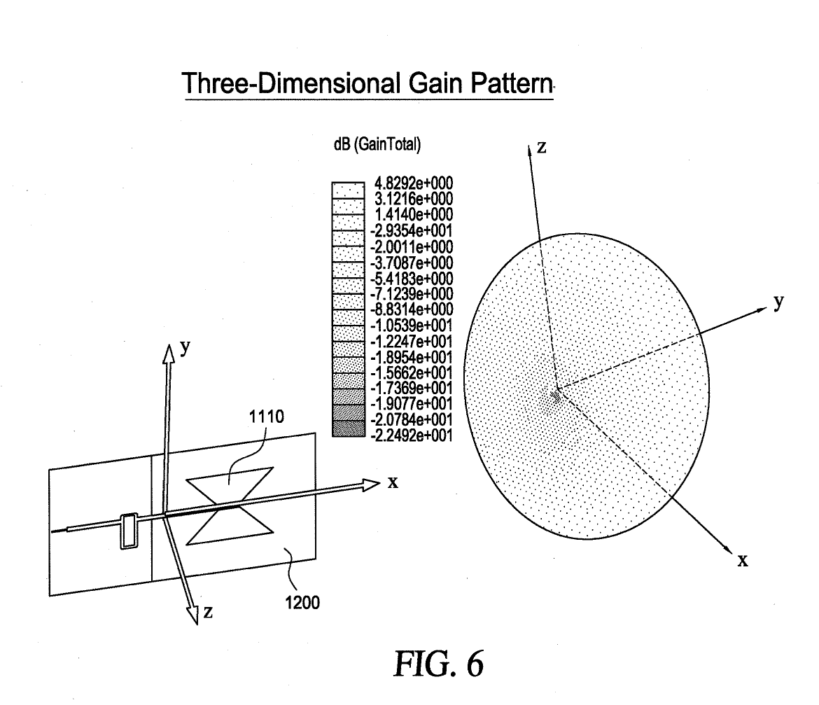

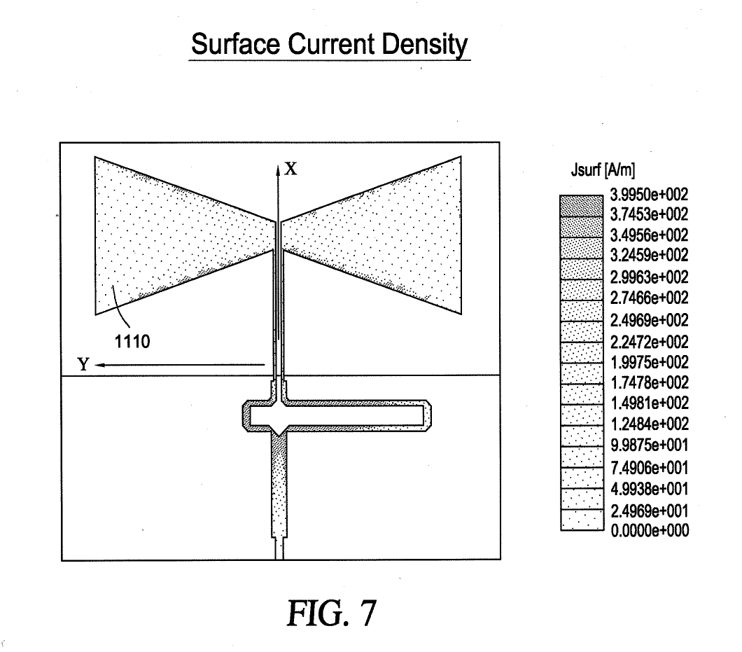

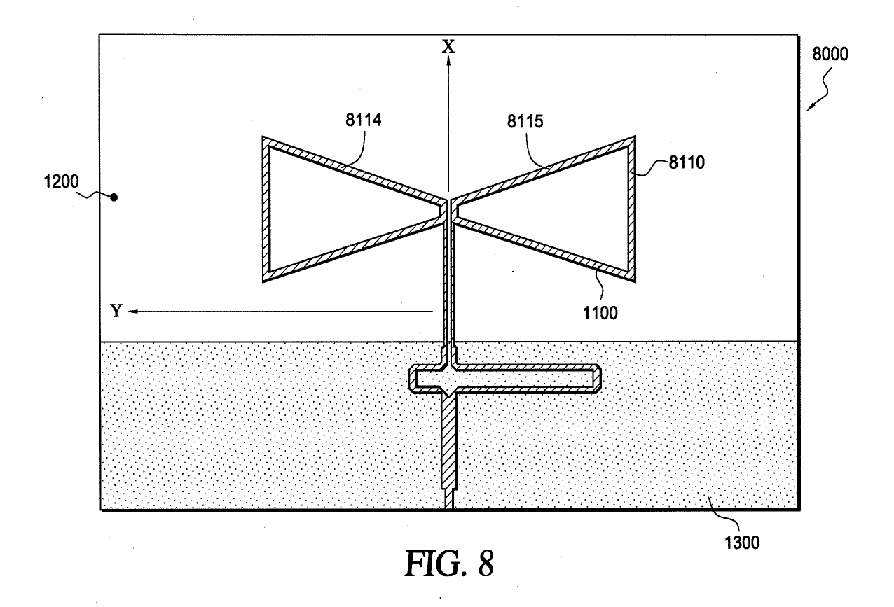

Turning to the drawings, FIG. 1 illustrates a diagram of a portion of antenna apparatus 1000, comprising antenna 1110 over substrate 1200. FIG. 2 illustrates a diagram of exemplary dimensions for antenna 1110 of FIG. 1. FIG. 3 illustrates a cross sectional view of a portion of antenna apparatus 1000 along line I-I in FIG. 1. FIG. 4 illustrates a top view of an implementation of antenna apparatus 1000. FIG. 5 illustrates a return loss graph for antenna apparatus 1000. FIG. 6 illustrates a three-dimensional gain pattern graph for antenna apparatus 1000. FIG. 7 illustrates a surface current density graph for antenna apparatus 1000. FIG. 8 illustrates a diagram of antenna apparatus 8000, similar to antenna apparatus 1000 of FIG. 1, but with a hollow inner portion. The different antenna apparatuses described herein are merely exemplary and are not limited to the presented embodiments. In addition, the antenna apparatuses described herein can be employed in many different embodiments or examples not specifically depicted or described in this application.

In the example of FIG. 1, antenna 1110 is presented as a bowtie antenna, although other types of antenna can be possible for different embodiments. For example, there can be embodiments comprising one or more of a monopole antenna, a dipole antenna, a spiral antenna, and/or a microstrip patch antenna. For simplicity in terms of description, however, the bow-tie antenna was selected for the present description. The bow-tie antenna is very popular, and its impedance bandwidth is suitable for wideband applications. Though bowtie antennas can be fabricated as a wire type of antenna, they can also be fabricated as a planar antenna, as in the case of antenna 1110.

Antenna 1110 is located over substrate 1200 as part of antenna layer 1100, and because substrate 1200 comprises a flexible material in the present example, antenna 1110 is configured to flex with substrate 1200 along with antenna layer 1100. Substrate 1200 can comprises a flexible plastic material, such as a polyethylene naphthalate (PEN) material similar to that available from Teijin DuPont Films of Tokyo, Japan under the trade name planarized “Teonex® Q65,” a polyethylene terephthalate (PET) material, a polyethersulfone (PES) material, a polyimide material, a polycarbonate material, a cyclic olefin copolymer, a liquid crystal polymer, and/or a polytetrafluoroethylene material similar to that available from Rogers Corporation of Chandler, Ariz. under the trade name RO3003, among others. In the same or other examples, substrate 1200 can be translucent and/or even substantially transparent. There can be examples where substrate 1200 comprises a thickness of approximately 0.1 millimeters (mm) to approximately 0.5 mm.

Antenna layer 1100 can be placed over substrate 1200 as part of a semiconductor manufacturing process in some examples. For instance, the semiconductor manufacturing process can overlay one or more layers of materials to form semiconductor devices such as thin film transistors (TFT) and/or antennas like antenna 1110 over a flexible substrate. As an example, to form TFTs in one such process, the flexible substrate can be coated with a planarizing layer and/or a silicon nitride layer. A gate metal, such as molybdenum, can be deposited and patterned over the substrate. A gate dielectric for the TFT can comprise silicon nitride, and an active layer can comprise hydrogenated amorphous silicon deposited with plasma enhanced chemical vapor deposition. A nitride passivation step can be performed before the contacts are etched. Source/drain metal can be sputtered on as an N+ amorphous silicon/aluminum bilayer. Depending on the application, another metallization step using materials such as indium tin oxide (ITO) and/or molybdenum can be carried out. Inter-level dielectrics can be silicon nitride with an optional planarizing layer between the aluminum and indium tin oxide metallization layers. The devices can be annealed after fabrication at, for example, 180° C. in a nitrogen atmosphere for 3 hours to simulate thermal cycling. There can be examples where a process such as the one described above can be used to manufacture flexible displays over the substrate defined and/or controlled by the TFTs.

Using the process described above, or other similar ones, one or more TFTs forming part of antenna apparatus 1000 can be developed to comprise a portion of a metallization layer deposited, printed, formed, or otherwise coupled over substrate 1200. In turn, antenna layer 1100 can be configured to comprise at least a portion of such metallization layer, such that antenna 1110 can be formed as part of one of the steps normally used to generate a portion of the one or more TFTs. In some examples, the metallization layer, and thus antenna layer 1200, can comprise at least one of an aluminum material, a molybdenum material, and/or a tantalum material. There can be examples where antenna layer 1200 can comprise a thickness of approximately 500 Angstroms to approximately 3000 angstroms. For instance, antenna layer 1200 can comprise a thickness of approximately 1000 Angstroms in some embodiments. As seen in FIG. 3, there can be examples where dielectric layer 3300 can be located between substrate 1200 and antenna layer 1100. There can be examples where dielectric layer 3300 can comprise a silicon nitride material. In the present example, dielectric layer 3300 comprises a relative permittivity or dielectric constant of about 7, and a thickness of about 0.0007 mm. Computer simulations suggest that the thickness of a silicon nitride layer with a dielectric constant of about 7 can have a thickness ranging from about 0.003 mm to 0.0007 mm without significantly affecting the loss versus frequency characteristic of the antenna. Substrate 1200 comprises a relative permittivity of about 3, and a thickness of about 0.128 mm. Other relative permittivities and thicknesses are possible in other embodiments using the same or different materials.

In the present example, as seen in FIG. 4, antenna apparatus 1000 comprises flexible display 4300 located over substrate 1200, where flexible display 4300 comprises a backplane with an array of TFTs to define and/or otherwise control pixels of flexible display 4300. There can be embodiments where flexible display 4300 is formed over substrate 1200 via a semiconductor process for TFTs such as described above. In such embodiments, antenna layer 1100 can comprise a portion of a layer, such as a metallization layer, shared with flexible display 4300. For example, antenna layer 1100 can comprise a portion of a metallization layer used to define source and/or drain contacts for the TFTs of flexible display 4300. In the same or other examples, antenna layer 1100 can comprise a portion of the backplane of flexible display 4300.

Antenna apparatus 1000 also comprises other possible components in the present example over substrate 1200, such as power source 4400, processing circuitry 4200, and transceiver 4100. There can be other embodiments where transceiver 4100 comprises a transmitter and a receiver structurally and/or diagrammatically separate from each other. Other embodiments may also comprise all or part of transceiver 4100 as part of processing circuitry 4200. In some implementations, one or more of processing circuitry 4200, power source 4400, and/or transceiver 4100 can be formed over substrate 1200 using a semiconductor process such as described above for the TFT's. Other implementations may comprise one or more components of antenna apparatus 1000 mounted over, rather than formed over, substrate 110. As an example, processing circuitry 4200, power source 4400, and/or transceiver 4100, can comprise one or more unpackaged bare dice mounted over substrate 1200. In the same or other examples, such similar unpackaged bare dice can be thinned before mounting over substrate 1200. There can be embodiments where a bare die mounted over substrate 110 can comprise commercial off the shelf (COTS) circuits and/or application specific integrated circuits (ASICs). There can be examples where at least some of the components described above can be configured to be flexible along with substrate 1200.

In the present embodiment, referring back to FIG. 1 where antenna 1110 is implemented as a bowtie antenna, antenna 1110 comprises arms 1112 and 1113. Arms 1112 and 1113 can route respective currents when antenna 1110 is used, and an impedance transformer can be implemented for antenna 1110 via balun 1111 to separate or otherwise control respective current phases of the currents thorough arms 1112 and 1113. In the present example, arms 1112 and 1113 of antenna 1110 are respectively coupled to ports 11112 and 11113 of balun 1111, and balun 1111 is configured to separate the phase of the currents of arms 1112 and 1113 by approximately 180 degrees. Port 11111 serves as an interface to the impedance transformer for antenna 1110 via balun 1111. Balun 1111 comprises a microstrip balun to transition a single-conductor line microstrip (port 11111) to a two-conductor line microstrip (ports 11112 and 11113) for antenna 1110 in the present example. Also in the present example, ground plane 1300 is located opposite the portion of antenna 1110 that comprises balun 1111 such that, as seen in FIG. 6, a directivity of antenna 1110 is enhanced in the X-axis in a direction normal to the edge of ground plane 1300. In the same or other examples, ground plane 1300 is at a first side of substrate 1200 and antenna layer 1100 is at a second side of substrate 1200, such that ground plane 1300, substrate 1200, and antenna layer 1100 form a stack with substrate 1200 in the middle, where balun 1111 and ground plane 1300 are opposite each other.

Development of the present embodiment of antenna 1110 focused on a target frequency of approximately 7 gigahertz to approximately 7.5 gigahertz. In the present example, as seen in FIG. 5, antenna 1110 was impedance matched such that the S₁₁ parameter for port 11111 yielded a minimum return loss of approximately −39 dB at approximately 7.35 gigahertz. At 7.25 gigahertz, the return loss was also found to be more than adequate at approximately −22 dB. Antenna 1110 was also developed to yield a gain of approximately 4 dBi to approximately 5 dBi, and, as seen in FIG. 6, a gain of approximately 4.7 dBi has been successfully simulated for the present design.

As seen in FIG. 1, antenna 1110 was configured such that antenna layer 1110 is continuous or solid across an area of element 1114 and an area of element 1115 of antenna 1110. As seen in FIG. 7, most of the surface current of antenna 1110 tends to concentrate at a perimeter of elements 1114 and 1115. Accordingly, other embodiments can be devised to take advantage of such surface current distribution. FIG. 8 illustrates one such embodiment, showing apparatus 8000 having antenna 8110 over substrate 1200, where antenna 8110 is similar to antenna 1110 (FIGS. 1-7), but comprises elements 8114 and 8115, instead of elements 1114 and 1115, such that antenna layer 1100 is present at the respective perimeters of elements 8114 and 8115 but not at their respective inner portions.

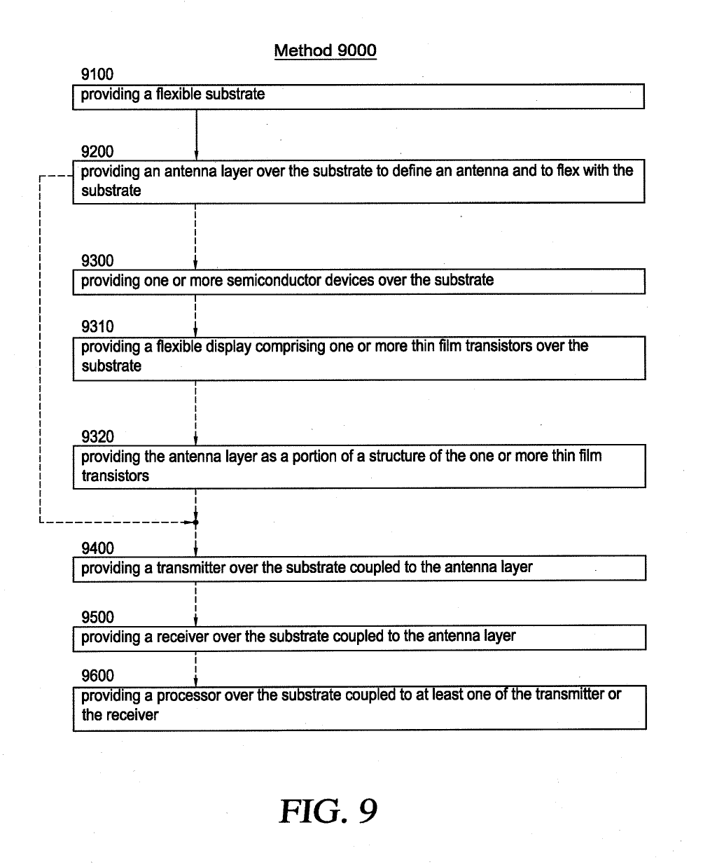

Continuing with the figures, FIG. 9 illustrates a flowchart of a method 9000 for providing an antenna over a flexible substrate in accordance with the present disclosure. In some examples, the antenna of method 9000 can be similar to antenna 1110 (FIGS. 1-4, 6-7) or antenna 8110 (FIG. 8).

Block 9100 of method 9000 comprises providing a flexible substrate. In some examples, the flexible substrate can be suitable for use in a semiconductor manufacturing process, and can be similar to substrate 1200 (FIGS. 1-8).

Block 9200 of method 9000 comprises providing an antenna layer over the substrate of block 9100 to define the antenna and to flex with the substrate. There can be examples where the antenna layer can be similar to antenna layer 1100 as described for FIGS. 1-8. In the same or other examples, the antenna layer can be deposited or otherwise formed over the substrate of block 9100 using a semiconductor process. The antenna layer need not directly contact the substrate, but rather could be located above other layers coupled to the substrate.

Block 9300 of method 9000 comprises providing one or more semiconductor devices over the substrate. In some embodiments, providing the one or more semiconductor devices can comprise forming at least a portion of one or more semiconductor devices over the substrate of block 9100. In the same or other embodiments, block 9300 could comprise coupling a portion of the one or more semiconductor devices to the substrate, such as by mounting one or more of the semiconductor devices as bare dice to the substrate. In such examples, the bare dice can be thinned before being coupled to the substrate, such that the bare dice can flex along with the substrate if needed.

In some implementations, block 9300 can comprise one or more sub-blocks.

As an example, block 9300 can comprise sub-block 9310 for providing a flexible display comprising one or more thin film transistors over the substrate. In some examples, the flexible display can be similar to flexible display 4300 as described above with respect to FIG. 4. Block 9300 can also comprise sub-block 9320 for providing the antenna layer as a portion of a structure of the one or more thin film transistors of sub-block 9310. For example, the antenna layer can comprise a portion of a metallization layer used to form one or more metallic components of the thin film transistors, such as source/drain contacts thereof. There can be other examples where the antenna layer can be provided in block 9200 to comprise a portion of a structure of at least one of the one or more semiconductor devices of block 9300, whether such one or more semiconductor devices comprise a flexible display or not.

Method 9000 can also comprise blocks 9400, 9500, and/or 9600 in some embodiments, where block 9400 comprises providing a transmitter over the substrate coupled to the antenna layer, block 9500 comprises providing a receiver over the substrate coupled to the antenna layer, and block 9600 comprises providing a processor over the substrate coupled to at least one of the transmitter or the receiver. There can be examples where the transmitter of block 9400 comprises a portion of transceiver 4100, as described above for FIG. 4. Similarly, there can be examples where the receiver of block 9500 comprises a portion of transceiver 4100. The processor of block 9600 can be similar to processing circuitry 4200 as described above for FIG. 4. In other embodiments, the receiver of block 9500 and/or the transmitter of block 9400 can be otherwise formed and/or coupled over the substrate of block 9100, whether independently or as part of other components such as part of processing circuitry 4200 in FIG. 4.

In some examples, one or more of the different blocks of method 9000 can be combined into a single block or performed simultaneously, and/or the sequence of such blocks can be changed. For example, in some embodiments, block 9200 could be carried out as part of, or simultaneously with, block 9300. Similarly, blocks 9400 and 9500 can be combined into a single step and/or can be performed simultaneously. In the same or other examples, some of the steps of method 9000 can be subdivided into several sub-steps. For example, sub-block 9310 could be further subdivided into several further sub-blocks for providing different layers of material used to form a structure of the one or more semiconductor devices. There can also be examples where method 9000 can comprise further or different procedures. As an example, method 9000 could comprise another sub-block for block 9100 for providing a dielectric layer over a body of the flexible substrate, such as the silicon nitrate layer shown in FIG. 3. Other variations can be implemented for method 9000 without departing from the scope of the present disclosure.

Although the flexible antennas and related apparatuses and methods have been described herein with reference to specific embodiments, various changes may be made without departing from the spirit or scope of the present disclosure. For example, in some embodiments, antenna layer 1100 could be a part of a stack of layers for other components of antenna apparatus 1000, such as transceiver 4100, processing circuitry 4200, power source 4400, and/or flexible display 4300 (FIG. 4). In such embodiments, an extra metallic layer could comprise antenna layer 1100. Additional examples of such changes have been given in the foregoing description. Accordingly, the disclosure of embodiments herein is intended to be illustrative of the scope of the invention and is not intended to be limiting. It is intended that the scope of this application shall be limited only to the extent required by the appended claims. The flexible antennas and related apparatuses and methods discussed herein may be implemented in a variety of embodiments, and the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus comprising:
a substrate; and
an antenna layer over the substrate;
wherein:
the substrate is flexible; and
the antenna layer is configured to flex with the substrate.

2. The apparatus of claim 1, further comprising:
one or more semiconductor devices over the substrate;
wherein:
the antenna layer comprises a portion of a structure of at least one of the one or more semiconductor devices.

3. The apparatus of claim 1, further comprising at least one of:
one or more thin film transistors over the substrate, the antenna layer defining an antenna over the substrate and comprising a portion of the one or more thin film transistors;
a processor at the substrate and at least one of (a) a transmitter at the substrate and coupled to the antenna layer or (b) a receiver at the substrate and coupled to the antenna layer, the processor being coupled to the at least one of the transmitter or the receiver;
a dielectric layer between the substrate and the antenna layer; or
a ground plane over the substrate, the antenna layer being located at a first side of the substrate and the ground plane being located at a second side of the substrate and opposite at least a portion of the antenna layer.

4. The apparatus of claim 1, wherein at least one of:
the apparatus comprises a flexible display over the substrate, the flexible display comprises a backplane, and the antenna layer comprises a portion of the backplane of the flexible display;
the substrate comprises a plastic substrate;
the substrate comprises a thickness of between 0.1 millimeter to 0.5 millimeters; or
the antenna layer comprises a metallization layer over the substrate.

5. The apparatus of claim 1, wherein at least one of:
the substrate comprises at least one of a polyethylene naphthalate material, a polyethylene terephthalate (PET) material, a polyethersulfone (PES) material, a polyimide material, a cyclic olefin copolymer material, a liquid crystal polymer material, or a polytetrafluoroethylene material;
the antenna layer comprises at least one of an aluminum material, a molybdenum material or a tantalum material; or
the antenna layer defines an antenna comprising at least one of a monopole antenna, a dipole antenna, a bowtie antenna, a spiral antenna, or a microstrip patch antenna.

6. The apparatus of claim 5, wherein at least one of:
when the antenna layer defines the antenna layer comprising the bowtie antenna, the antenna comprises the bowtie antenna having first and second elements and the antenna layer is solid across an entire area of the first and second elements; or
when the antenna layer defines the antenna layer comprising the bowtie antenna, an inner portion of an area of the antenna is devoid of the antenna layer.

7. The apparatus of claim 1, wherein:
the antenna layer comprises a bowtie antenna across at least a portion of the substrate;
the bowtie antenna comprises:
a first arm coupled to a first portion of the bowtie antenna to route a first current; and
a second arm coupled to a second portion of the bowtie antenna to route a second current;
the antenna layer further comprises an impedance transformer having a microstrip balun, the microstrip balun comprising:
a first port coupled to an input of the impedance transformer;
a second port coupled to the first arm of the bowtie antenna; and
a third port coupled to the second arm of the bowtie antenna; and
the microstrip balun is configured to separate current phases of the first and second currents by approximately 180 degrees.

8. The apparatus of claim 1, wherein:
the antenna layer comprises a bowtie antenna; and
at least one of:
the bowtie antenna is impedance matched to minimize a return loss at a target frequency of between approximately 7 gigahertz to approximately 7.5 gigahertz;
the bowtie antenna is configured to deliver a gain of approximately 4 dBi to approximately 5 dBi; or
a return loss of the bowtie antenna is less than −20 dB.

9. An apparatus comprising:
a substrate comprising a dielectric material;
one or more layers over the substrate defining one or more semiconductor devices;
wherein:
the substrate comprises a plastic substrate;
the one or more layers comprises a metallization layer; and
the one or more semiconductor devices comprise an antenna defined at least in part by the metallization layer.

10. The apparatus of claim 9, wherein:
the substrate is flexible;
the one or more layers are configured to flex with the substrate;
the one or more semiconductor devices further comprise an array of thin film transistors defining a flexible display; and
at least a portion of a structure of the thin film transistors is defined by the metallization layer.

11. The apparatus of claim 9, further comprising:
at least one of:
a transmitter at the substrate and coupled to the metallization layer, or
a receiver at the substrate and coupled to the metallization layer; and
a processor coupled to the at least one of the transmitter or the receiver.

12. The apparatus of claim 9, wherein at least one of:
the antenna comprises at least one of a monopole antenna, a dipole antenna, a spiral antenna, or a microstrip patch antenna, and the antenna extends over at least a portion of the substrate; or
the metallization layer is present at a perimeter of the antenna, and an inner area of the antenna is devoid of the metallization layer.

13. A method comprising:
providing a flexible substrate; and
providing an antenna layer over the substrate to define an antenna;
wherein:
the antenna layer is configured to flex with the substrate.

14. The method of claim 13, further comprising:
providing one or more semiconductor devices over the substrate;
wherein:
providing the antenna layer comprises:
providing the antenna layer to comprise a portion of a structure of at least one of the one or more semiconductor devices.

15. The method of claim 13, further comprising:
providing a flexible display over the substrate;
wherein:
providing the flexible display comprises:
forming an array of one or more thin film transistors over the substrate to control pixels of the flexible display; and
providing the antenna layer comprises:
providing the antenna layer to form a portion of a structure of the one or more thin film transistors.

16. The method of claim 13, further comprising:
providing a flexible display over the substrate, the flexible display having a backplane;
wherein:
providing the antenna layer comprises:
providing the antenna to comprise a portion of the backplane of the flexible display.

17. The method of claim 13, wherein:
providing the flexible substrate comprises:
providing the flexible substrate to comprise at least one of:
a polyethylene naphthalate material;
a polyethylene terephthalate (PET) material,
a polyethersulfone (PES) material;
a polyimide material;
a cyclic olefin copolymer material;
a liquid crystal polymer material; or
a polytetrafluoroethylene material;
and
providing the antenna layer comprises:
providing the antenna layer to comprise at least one of:
an aluminum material;
a molybdenum material; or
a tantalum material.

18. The method of claim 13, further comprising at least one of:
providing a transmitter over the substrate coupled to the antenna layer; or
providing a receiver over the substrate coupled to the antenna layer.

19. The method of claim 18, further comprising:
providing a processor over the substrate coupled to at least one of the transmitter or the receiver;
wherein:
at least one of providing the transmitter, the receiver, or the processor comprises at least one of:
forming the transmitter, the receiver, or the processor over the substrate; or
coupling the transmitter, the receiver, or the processor as a bare die over the substrate.

20. The method of claim 13, wherein:
providing the antenna layer comprises at least one of:
providing the antenna to comprise a first arm of the antenna to route a first current, a second arm of the antenna to route a second current, and a balun coupled between the first and second arms of the antenna to separate current phases of the first and second currents;
configuring the antenna for at least one of (a) limiting a return loss at a target frequency of between 7 gigahertz to 7.5 gigahertz, (b) delivering a gain of 4 dBi to 5 dBi, or (c) limiting the return loss to less than −20 dB at the target frequency; or
providing a material of the antenna layer to be concentrated at a perimeter of the antenna.
